(19) United States
(12) Patent Application Publication
(10) Pub. No.: US 2025/0149006 A1
(43) Pub. Date: May 8, 2025

(54) PIXEL DRIVING CIRCUIT AND DISPLAY PANEL

(71) Applicant: Wuhan China Star Optoelectronics Technology Co., Ltd., Wuhan (CN)

(72) Inventors: Bo LIU, Wuhan (CN); Qiang GONG, Wuhan (CN)

(21) Appl. No.: 17/792,448

(22) PCT Filed: Jun. 30, 2022
(86) PCT No.: PCT/CN2022/102739

§ 371 Date: Jan. 27, 2025

(30) Foreign Application Priority Data
Jun. 16, 2022 (CN) 202210689396.X

(51) Int. Cl. G09G 3/36

(52) U.S. Cl. CPC G09G 3/3614; G09G 3/3648; G09G 2300/043; G09G 2300/0852; G09G 2310/0251; G09G 2310/065; G09G 2310/08; G09G 2330/023

(57) ABSTRACT

The present application discloses a pixel driving circuit and a display panel. Before the charging module charges the pixel electrode, the present application releases the voltage of the pixel electrode by means of the discharging electrode. Therefore, it is possible to avoid that the voltage of the pixel electrode is charged to a target value after the residual voltage on the pixel electrode needs to be canceled during charging the pixel electrode by the charging module. As a result, the power consumption of the pixel electrode during the charging/discharging process can be reduced, and the charging/discharging time period of the pixel electrode can be reduced.

### TECHNICAL FIELD

The present application relates to a field of display technology, and more particularly to a pixel driving circuit and a display panel.

### BACKGROUND

A thin film transistor liquid crystal display panel has many advantages such as thin body, power saving, and no radiation, and has been widely applied to various aspects of life, such as a small-sized smartphone, a video camera, a digital camera, a medium-sized notebook computer, a desktop computer, a large-sized home television, and a large-sized projection device.

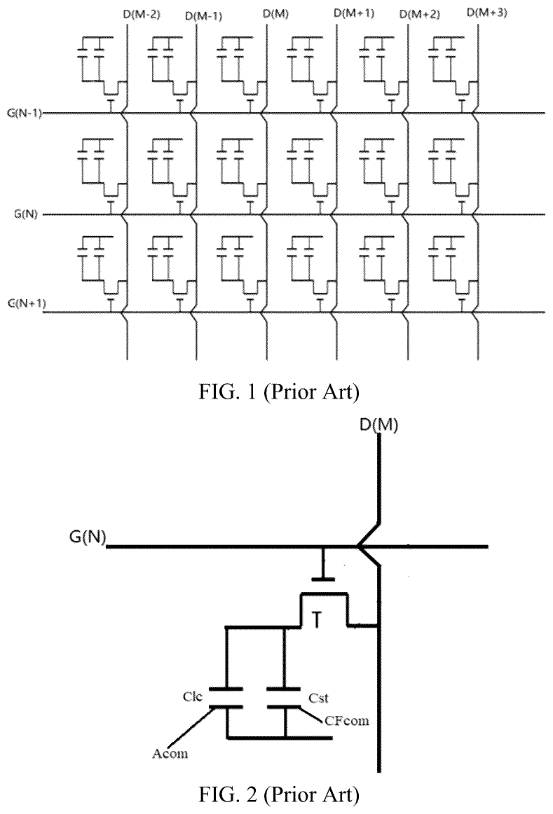

As shown in FIG. 1, a conventional liquid crystal display panel includes a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines. Referring to FIGS. 1 and 2, each of the sub-pixels is provided with a pixel driving circuit. The pixel driving circuit includes a thin film transistor, and M and N are both preset as positive integers. For a sub-pixel in the Nth row and the Mth column, a gate of a thin film transistor T of the sub-pixel is electrically connected to the Nth scanning line G(N), a drain of the thin film transistor T of the sub-pixel is electrically connected to the Mth data line D(M), and a source of the thin film transistor T of the sub-pixel is electrically connected to a pixel electrode which is further electrically connected to a storage capacitor Cst and a liquid crystal capacitor Clc. Two electrode plates of the storage capacitor Cst are a pixel electrode and a common electrode CFcoN on the array substrate side, respectively, and two electrode plates of the liquid crystal capacitor Clc are a pixel electrode and a common electrode AcoN on the color film substrate side, respectively.

It may be known from the above that the pixel driving circuit of the conventional sub-pixel controls writing of the voltage of the pixel electrode by means of the thin film transistor. The thin film transistor is turned on to write a data line signal to the pixel electrode when its gate is connected to a high level signal. In addition, positive and negative polarities of the voltage of the pixel electrode are inverted once per frame. Therefore, when the voltage of the pixel electrode is changed from the first polarity to the second polarity, the first polarity is the positive polarity and the second polarity is the negative polarity, or the first polarity is the negative polarity and the second polarity is the positive polarity. Since the residual voltage of the first polarity is also present on the pixel electrode, and the first polarity and the second polarity are opposite electric polarities, it is necessary to cancel the residual voltage of the first polarity on the pixel electrode and then charge the voltage of the pixel electrode to a voltage of the second polarity. Therefore, the pixel electrode consumes a large amount of power during a charging/discharging process and needs a long time to make the voltage of the pixel electrode reach a target value.

### SUMMARY

### Technical Problems

The present application provides a pixel driving circuit and a display panel to solve a technical problem that a pixel electrode consumes a large amount of power during a charging/discharging process and the process is time-consuming and excessively long.

### Solution to Problem

### Technical Solution

The present application provides a pixel driving circuit, comprising:
pixel electrode;
a charging module electrically connected to a data line, a scanning line, and the pixel electrode, wherein the charging module is configured to write a signal of the data line to the pixel electrode under the control of a signal of the scanning line; and
a discharging module electrically connected to a signal control line, a discharge electrode, and the pixel electrode, wherein the discharging module is configured to connect the pixel electrode to the discharging electrode under the control of a signal of the signal control line.

Optionally, in some embodiments of the present application, the pixel driving circuit further comprises:
a storage capacitor, wherein a first electrode of the storage capacitor is the pixel electrode, a second electrode of the storage capacitor is a first common electrode, and the discharge electrode comprises the first common electrode.

Optionally, in some embodiments of the present application, the pixel driving circuit further comprises:
a liquid crystal capacitor, wherein a first electrode of the liquid crystal capacitor is the pixel electrode, a second electrode of the liquid crystal capacitor is a second common electrode, and the discharge electrode comprises the second common electrode.

Optionally, in some embodiments of the present application, the charging module comprises:
a first transistor, wherein a gate of the first transistor is electrically connected to the scanning line, one of a source and a drain of the first transistor is electrically connected to the data line, and the other one of the source and the drain of the first transistor is electrically connected to the pixel electrode.

Optionally, in some embodiments of the present application, the discharging module comprises:
a second transistor, wherein a gate of the second transistor is electrically connected to the signal control line, one of a source and a drain of the second transistor is electrically connected to the pixel electrode, and the other one of the source and the drain of the second transistor is electrically connected to the discharge electrode.

Optionally, in some embodiments of the present application, the pixel driving circuit further comprises:
a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines;
wherein, both M and N are preset as positive integers, N is greater than or equal to 2, and the charging module is electrically connected to the Mth data line, the Nth scanning line, and the pixel electrode in the Nth row and the Mth column;
wherein, the signal control line is the (N−1)th scanning line, and the discharging module is electrically connected to the (N−1)th scanning line, the discharge electrode, and the pixel electrode in the Nth row and the Mth column.

Optionally, in some embodiments of the present application, the charging module comprises:
a first transistor, wherein a gate of the first transistor is electrically connected to the Nth scanning line, one of a source and a drain of the first transistor is electrically connected to the Mth data line, and the other one of the source and the drain of the first transistor is electrically connected to the pixel electrode in the Nth row and the Mth column;
the discharging module comprises:
a second transistor, wherein a gate of the second transistor is electrically connected to the (N−1)th scanning line, one of a source and a drain of the second transistor is electrically connected to the pixel electrode in the Nth row and the Mth column, and the other one of the source and the drain of the second transistor is electrically connected to the discharge electrode;
wherein both the first transistor and the second transistor are N-type transistors or P-type transistors.

Optionally, in some embodiments of the present application, the pixel driving circuit further comprises:
a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines;
wherein, both M and N are preset as positive integers, and the charging module is electrically connected to the Mth data line, the Nth scanning line, and the pixel electrode in the Nth row and the Mth column;
wherein, the signal control line is the Nth scanning line, and the discharging module is electrically connected to the Nth scanning line, the discharge electrode, and the pixel electrode in the Nth row and the Mth column;
wherein, the charging module writes a signal of the Mth data line into the pixel electrode in the Nth row and the Mth column when the signal of the Nth scanning line has a first polarity;
the discharging module connects the pixel electrode in the Nth row and the Mth column with the discharge electrode when the signal of the Nth scanning line has a second polarity, wherein the first polarity is one of a positive polarity and a negative polarity, and the second polarity is the other one of the positive polarity and the negative polarity.

Optionally, in some embodiments of the present application, the charging module comprises:
a first transistor, wherein a gate of the first transistor is electrically connected to the Nth scanning line, one of a source and a drain of the first transistor is electrically connected to the Mth data line, and the other one of the source and the drain of the first transistor is electrically connected to the pixel electrode in the Nth row and the Mth column;
the discharging module comprises:
a second transistor, wherein a gate of the second transistor is electrically connected to the Nth scanning line, one of a source and a drain of the second transistor is electrically connected to the pixel electrode in the Nth row and the Mth column, and the other one of the source and the drain of the second transistor is electrically connected to the discharge electrode;
wherein the first transistor is an N-type transistor or a P-type transistor, and the second transistor is a P-type transistor or an N-type transistor.

Optionally, in some embodiments of the present application, the discharging electrode is a ground terminal.

Correspondingly, the present application further provides a display device, comprising a pixel driving circuit;
the pixel driving circuit comprises:
a pixel electrode;
a charging module electrically connected to a data line, a scanning line, and the pixel electrode, wherein the charging module is configured to write a signal of the data line to the pixel electrode under the control of a signal of the scanning line; and
a discharging module electrically connected to a signal control line, a discharge electrode, and the pixel electrode, wherein the discharging module is configured to connect the pixel electrode to the discharging electrode under the control of a signal of the signal control line.

Optionally, in some embodiments of the present application, the pixel driving circuit further comprises:
a storage capacitor, wherein a first electrode of the storage capacitor is the pixel electrode, a second electrode of the storage capacitor is a first common electrode, and the discharge electrode comprises the first common electrode.

Optionally, in some embodiments of the present application, the pixel driving circuit further comprises:
a liquid crystal capacitor, wherein a first electrode of the liquid crystal capacitor is the pixel electrode, a second electrode of the liquid crystal capacitor is a second common electrode, and the discharge electrode comprises the second common electrode.

Optionally, in some embodiments of the present application, the charging module comprises:
a first transistor, wherein a gate of the first transistor is electrically connected to the scanning line, one of a source and a drain of the first transistor is electrically connected to the data line, and the other one of the source and the drain of the first transistor is electrically connected to the pixel electrode.

Optionally, in some embodiments of the present application, the discharging module comprises:
a second transistor, wherein a gate of the second transistor is electrically connected to the signal control line, one of a source and a drain of the second transistor is electrically connected to the pixel electrode, and the other one of the source and the drain of the second transistor is electrically connected to the discharge electrode.

Optionally, in some embodiments of the present application, the pixel driving circuit further comprises:
a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines;
wherein, both M and N are preset as positive integers, N is greater than or equal to 2, and the charging module is electrically connected to the Mth data line, the Nth scanning line, and the pixel electrode in the Nth row and the Mth column;
wherein, the signal control line is the (N−1)th scanning line, and the discharging module is electrically connected to the (N−1)th scanning line, the discharge electrode, and the pixel electrode in the Nth row and the Mth column.

Optionally, in some embodiments of the present application, the charging module comprises:
a first transistor, wherein a gate of the first transistor is electrically connected to the Nth scanning line, one of a source and a drain of the first transistor is electrically connected to the Mth data line, and the other one of the source and the drain of the first transistor is electrically connected to the pixel electrode in the Nth row and the Mth column;
the discharging module comprises:
a second transistor, wherein a gate of the second transistor is electrically connected to the (N−1)th scanning line, one of a source and a drain of the second transistor is electrically connected to the pixel electrode in the Nth row and the Mth column, and the other one of the source and the drain of the second transistor is electrically connected to the discharge electrode;
wherein both the first transistor and the second transistor are N-type transistors or P-type transistors.

Optionally, in some embodiments of the present application, the pixel driving circuit further comprises:
a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines;
wherein, both M and N are preset as positive integers, and the charging module is electrically connected to the Mth data line, the Nth scanning line, and the pixel electrode in the Nth row and the Mth column;
wherein, the signal control line is the Nth scanning line, and the discharging module is electrically connected to the Nth scanning line, the discharge electrode, and the pixel electrode in the Nth row and the Mth column;
wherein, the charging module writes a signal of the Mth data line into the pixel electrode in the Nth row and the Mth column when the signal of the Nth scanning line has a first polarity;
the discharging module connects the pixel electrode in the Nth row and the Mth column with the discharge electrode when the signal of the Nth scanning line has a second polarity, wherein the first polarity is one of a positive polarity and a negative polarity, and the second polarity is the other one of the positive polarity and the negative polarity.

Optionally, in some embodiments of the present application, the charging module comprises:
a first transistor, wherein a gate of the first transistor is electrically connected to the Nth scanning line, one of a source and a drain of the first transistor is electrically connected to the Mth data line, and the other one of the source and the drain of the first transistor is electrically connected to the pixel electrode in the Nth row and the Mth column;
the discharging module comprises:
a second transistor, wherein a gate of the second transistor is electrically connected to the Nth scanning line, one of a source and a drain of the second transistor is electrically connected to the pixel electrode in the Nth row and the Mth column, and the other one of the source and the drain of the second transistor is electrically connected to the discharge electrode;
wherein the first transistor is an N-type transistor or a P-type transistor, and the second transistor is a P-type transistor or an N-type transistor.

Optionally, in some embodiments of the present application, the discharging electrode is a ground terminal.

### BENEFICIAL EFFECTS OF PRESENT DISCLOSURE

### Beneficial Effects

The present application provides the pixel driving circuit and the display panel, wherein the pixel driving circuit comprises: the pixel electrode; the charging module electrically connected to the data line, the scanning line, and the pixel electrode, wherein the charging module is configured to write the signal of the data line into the pixel electrode under the control of the signal of the scanning line; and the discharging module electrically connected to the signal control line, the discharge electrode, and the pixel electrode, wherein the discharging module is configured to connect the pixel electrode to the discharge electrode under the control of the signal of the signal control line. According to the present application, before the charging module charges the pixel electrode, the discharging module is used to connect the pixel electrode with the discharging electrode to release the voltage of the pixel electrode by means of the discharging electrode, so that the voltage of the pixel electrode is restored to zero or close to zero. Therefore, it is possible to avoid that the voltage of the pixel electrode is charged to a target value after the residual voltage on the pixel electrode needs to be canceled during charging the pixel electrode by the charging module. As a result, the power consumption of the pixel electrode during the charging/discharging process can be reduced, and the charging/discharging time period of the pixel electrode can be reduced.

### BRIEF DESCRIPTION OF DRAWINGS

### Description of Drawings

In order to more clearly illustrate the technical solutions in embodiments of the present disclosure, the accompanying drawings depicted in the description of the embodiments will be briefly described below. It will be apparent that the accompanying drawings in the following description are merely some embodiments of the present disclosure, and other drawings may be obtained from these drawings without creative effort by those skilled in the art.

FIG. 1 is a schematic diagram of a pixel driving circuit of a liquid crystal display panel in the prior art;

FIG. 2 is a schematic diagram of the pixel driving circuit in the Nth row and the Mth column in FIG. 1;

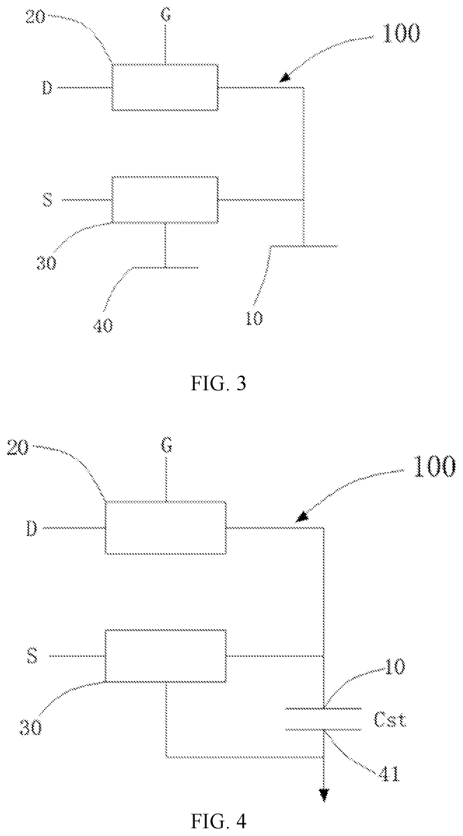

FIG. 3 is a first schematic structural diagram of a pixel driving circuit provided in the present application;

FIG. 4 is a second schematic structural diagram of a pixel driving circuit provided in the present application;

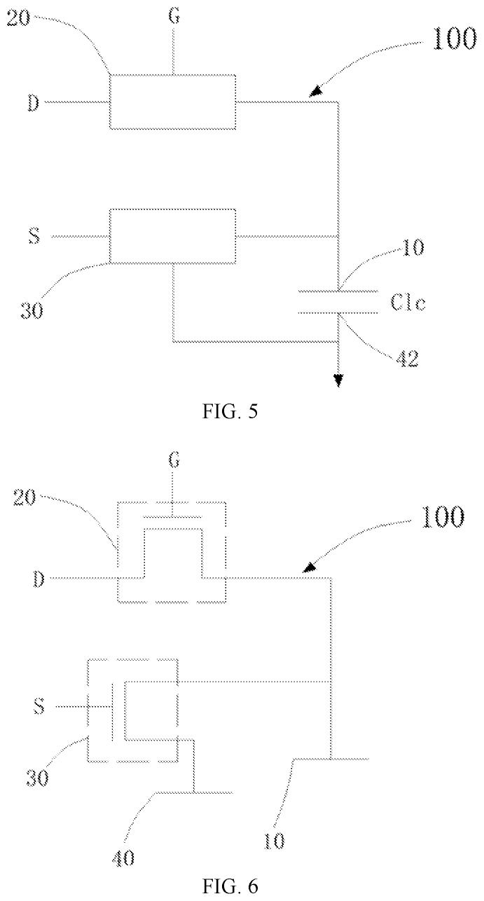

FIG. 5 is a third schematic structural diagram of a pixel driving circuit provided in the present application;

FIG. 6 is a fourth schematic structural diagram of a pixel driving circuit provided in the present application;

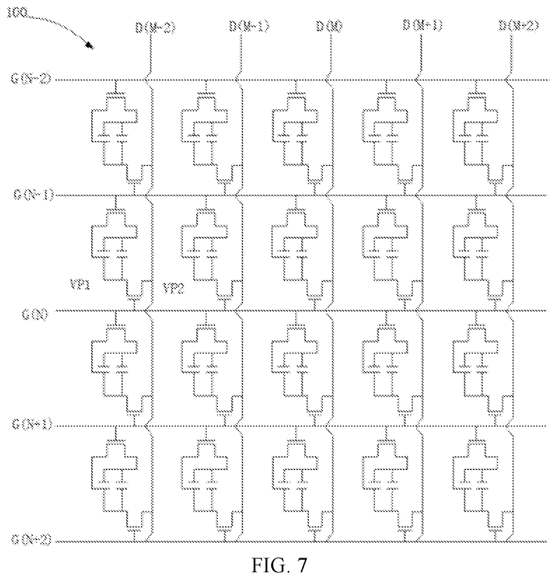

FIG. 7 is a fifth schematic structural diagram of a pixel driving circuit provided in the present application;

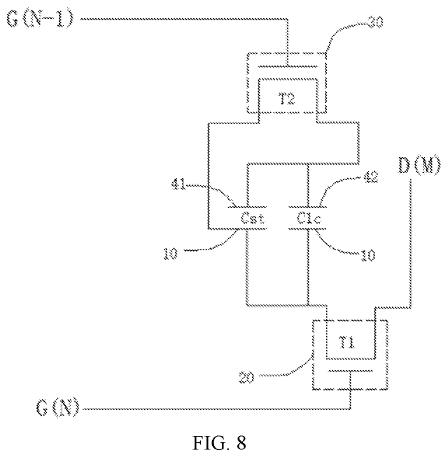

FIG. 8 is a schematic diagram of the pixel driving circuit in the Nth row and the Mth column in FIG. 7;

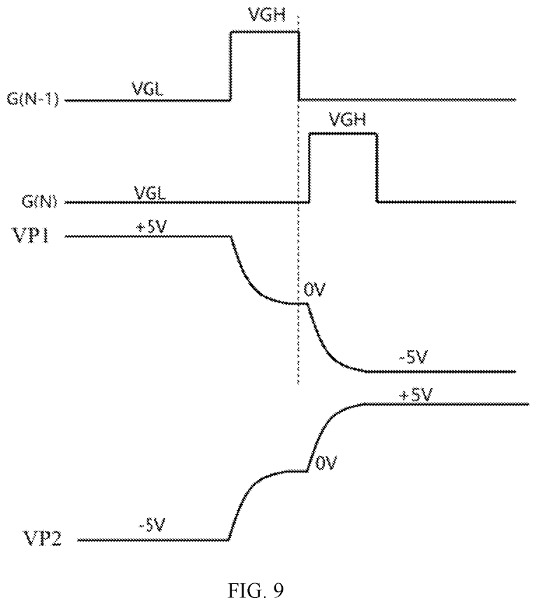

FIG. 9 is a voltage timing diagram of a pixel electrode of a sub-pixel VP1 and a pixel electrode of a sub-pixel VP2 in FIG. 7;

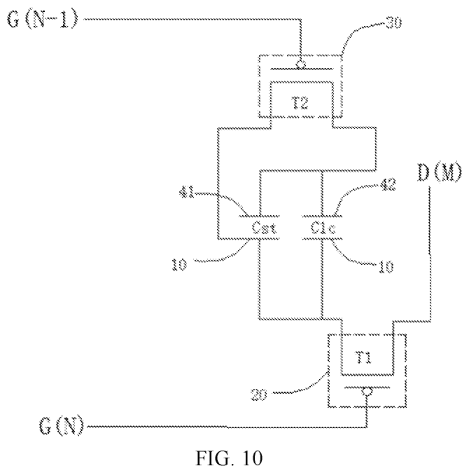

FIG. 10 is a sixth schematic structural diagram of a pixel driving circuit provided in the present application;

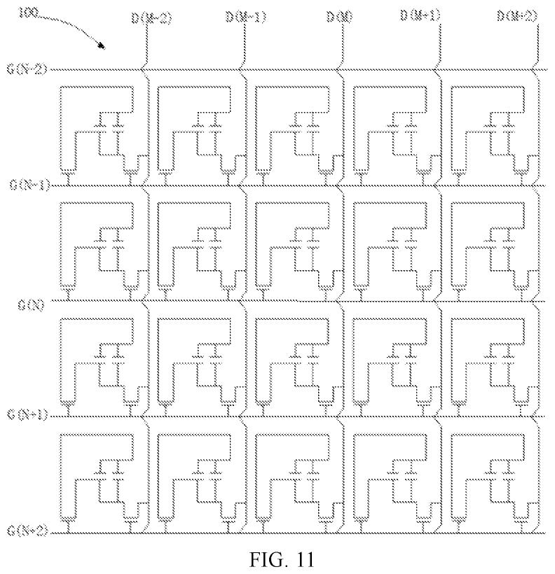

FIG. 11 is a seventh schematic structural diagram of a pixel driving circuit provided in the present application;

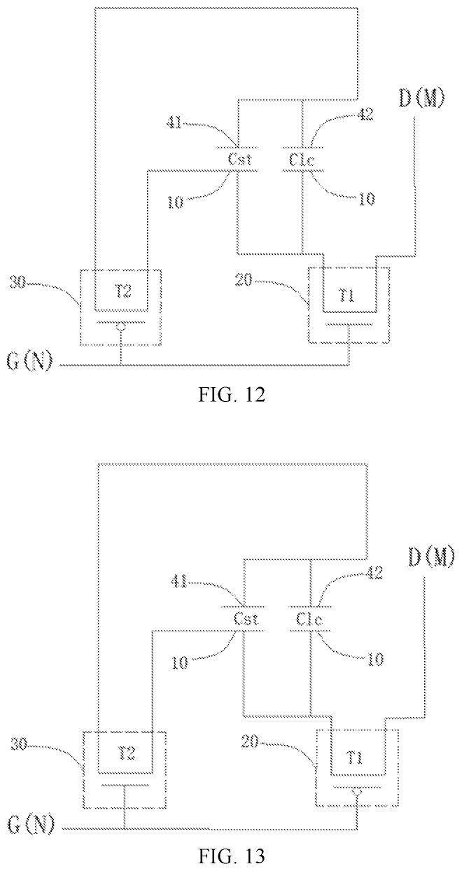

FIG. 12 is a schematic diagram of the pixel driving circuit in the Nth row and the Mth column in FIG. 11; and

FIG. 13 is an eighth schematic structural diagram of a pixel driving circuit provided in the present application.

### EMBODIMENTS OF THE PRESENT DISCLOSURE

### Detailed Description of Preferred Embodiments

Technical solutions in embodiments of the present disclosure will be clearly and completely described below in conjunction with drawings in the embodiments of the present disclosure. Obviously, the described embodiments are only a part of embodiments of the present disclosure, rather than all the embodiments. Based on the embodiments in the present disclosure, all other embodiments obtained by those skilled in the art without creative work fall within the protection scope of the present disclosure.

In the description of the present disclosure, it should be understood that the term “first”, “second” are for illustrative purposes only and are not to be construed as indicating or imposing a relative importance or implicitly indicating the number of technical features indicated. Thus, a feature that limited by “first”, “second” may expressly or implicitly include at least one of the features. In the description of the present disclosure, the meaning of “plurality” is two or more, unless otherwise specifically defined.

The transistors used in all embodiments of the present disclosure may be thin film transistors, field effect transistors, or other devices with same characteristics. Since a source and a drain of the transistor used herein are symmetrical, the source and drain of the transistor may be interchanged. In an embodiment of the present disclosure, to distinguish between two electrodes of a transistor except the gate, one of the two electrodes is referred to as a source, and the other one of the two electrodes is referred to as a drain. It is provided as shown in drawings that a middle terminal of a control module represents a gate, a signal input terminal thereof represents a source, and an output terminal thereof is a drain. In addition, the transistors used in the embodiments of present application may include a P-type transistor and/or an N-type transistor. The P-type transistor is turned on when a gate of the P-type transistor is at a low level, and is turned off when the gate thereof is at a high level. The N-type transistor is turned on when a gate of the N-type transistor is at a high level, and is turned off when the gate thereof is at a low level.

The present application provides a pixel driving circuit and a display device, which are illustrated in detail below. It should be noted that the description order of the following embodiments of the present disclosure is not intended to limit the preferred order of the embodiments.

Referring to FIG. 3, which is a first schematic structural diagram of a pixel driving circuit 100 provided in the present application. The present application provides a pixel driving circuit 100, including: a pixel electrode 10, a charging module 20, and a discharging module 30.

The charging module 20 is electrically connected to a data line D, a scanning line G, and the pixel electrode 10, and configured to write a signal of the data line D to the pixel electrode 10 under the control of a signal of the scanning line G.

The discharging module 30 is electrically connected to a signal control line S, a discharge electrode 40, and the pixel electrode 10, and configured to connect the pixel electrode 10 to the discharging electrode 40 under the control of a signal of the signal control line S.

Positive and negative polarities of the voltage of the existing pixel electrode 10 are inverted once per frame. Therefore, when the voltage of the pixel electrode 10 is changed from the first polarity to the second polarity, the first polarity is the positive polarity and the second polarity is the negative polarity, or the first polarity is the negative polarity and the second polarity is the positive polarity. Since the residual voltage of the first polarity is also present on the pixel electrode 10, and the first polarity and the second polarity are opposite electric polarities, it is necessary to cancel the residual voltage of the first polarity on the pixel electrode 10 and then charge the voltage of the pixel electrode 10 to a voltage of the second polarity. As such, the pixel electrode 10 consumes a large amount of power during a charging/discharging process and needs a long time to make the voltage of the pixel electrode 10 reach a target value.

However, in the present application, before the charging module 20 charges the pixel electrode 10, the discharging module 30 is used to connect the pixel electrode 10 with the discharging electrode 40 to release the voltage of the pixel electrode 10 by means of the discharging electrode 40, so that the voltage of the pixel electrode 10 is restored to zero or close to zero. Therefore, it is possible to avoid that the voltage of the pixel electrode 10 is charged to a target value after the residual voltage on the pixel electrode 10 needs to be canceled during charging the pixel electrode 10 by the charging module 20. As a result, the power consumption of the pixel electrode 10 during the charging/discharging process can be reduced, and the charging/discharging time period of the pixel electrode 10 can be reduced.

Specifically, the discharge electrode 40 may be a ground terminal. In addition, a voltage polarity of the discharge electrode 40 may be opposite to a voltage polarity of the pixel electrode 10, so that the discharge electrode 40 may release the voltage of the pixel electrode 10 so as to make the voltage of the pixel electrode 10 restore to zero or close to zero.

Referring to FIG. 4, which is a second schematic structural diagram of a pixel driving circuit 100 provided in the present application. In the embodiment, the pixel driving circuit further includes: a storage capacitor Cst, where a first electrode of the storage capacitor Cst is the pixel electrode 10, a second electrode of the storage capacitor Cst is a first common electrode 41, and the discharge electrode 40 includes the first common electrode 41.

The first common electrode 41 is a common electrode on the array substrate side. That is, two electrode plates of the storage capacitor are the pixel electrode 10 and the common electrode on the array substrate side, respectively. The discharge module 30 is configured to connect the pixel electrode 10 to the common electrode on the array substrate side under the control the signal of the signal control line S. As such, wiring arrangement of the pixel driving circuit can be reduced. The first common electrode 41 is generally connected to the ground terminal, or a voltage polarity of the first common electrode 41 is opposite to a voltage polarity of the pixel electrode 10, so that, when the pixel electrode 10 is connected to the common electrode on the array substrate side, the voltage of the pixel electrode 10 can be released and restored to zero or close to zero.

Referring to FIG. 5, which is a third schematic structural diagram of a pixel driving circuit 100 provided in the present application. In the embodiment, the pixel driving circuit further includes: a liquid crystal capacitor Clc, where a first electrode of the liquid crystal capacitor Clc is the pixel electrode 10, a second electrode of the liquid crystal capacitor Clc is a second common electrode 42, and the discharge electrode 40 includes the second common electrode 42.

The second common electrode 42 is a common electrode on the color film substrate side. That is, two electrode plates of the liquid crystal capacitor Clc are the pixel electrode 10 and the common electrode on the color film substrate side, respectively. The discharge module 30 is configured to connect the pixel electrode 10 to the common electrode on the color film substrate side under the control the signal of the signal control line S. As such, wiring arrangement of the pixel driving circuit can be reduced. The second common electrode 42 is generally connected to the ground terminal, or a voltage polarity of the second common electrode 42 is opposite to a voltage polarity of the pixel electrode 10, so that, when the pixel electrode 10 is connected to the common electrode on the array substrate side, the voltage of the pixel electrode 10 can be released and restored to zero or close to zero.

Referring to FIG. 6, which is a fourth schematic structural diagram of a pixel driving circuit 100 provided in the present application. In the embodiment, the charging module 20 includes: a first transistor T1, wherein a gate of the first transistor T1 is electrically connected to the scanning line G, one of a source and a drain of the first transistor T1 is electrically connected to the data line D, and the other one of the source and the drain of the first transistor T1 is electrically connected to the pixel electrode 10.

In some embodiments, the discharging module 30 includes: a second transistor T2, wherein a gate of the second transistor T2 is electrically connected to the signal control line S, one of a source and a drain of the second transistor T2 is electrically connected to the pixel electrode 10, and the other one of the source and the drain of the second transistor T2 is electrically connected to the discharge electrode 40.

Referring to FIG. 7, which is a fifth schematic structural diagram of a pixel driving circuit 100 provided in the present application; and FIG. 8 is a schematic diagram of the pixel driving circuit 100 in the Nth row and the Mth column in FIG. 7. In the embodiment, the pixel driving circuit further includes: a plurality of scanning lines G extending in a transverse direction that are sequentially arranged from top to bottom, a plurality of data lines D extending in a longitudinal direction that are sequentially arranged from left to right and insulated from the plurality of scanning lines G, and a plurality of sub-pixels arranged in an array that are defined by the plurality of scanning lines G and the plurality of data lines D; where, both M and N are preset as positive integers, N is greater than or equal to 2, and the charging module 20 is electrically connected to the Mth data line D(M), the Nth scanning line G(N), and the pixel electrode 10 in the Nth row and the Mth column; where, the signal control line S is the (N−1)th scanning line G(N−1), and the discharging module 30 is electrically connected to the (N−1)th scanning line G(N−1), the discharge electrode 40, and the pixel electrode 10 in the Nth row and the Mth column.

In the present application, the signal control line S is set as the (N−1)th scanning line G(N−1), and the charging module 20 is configured to write a signal of the Mth data line D(M) into the pixel electrode 10 in the Nth row and the Mth column under the control of the Nth scanning line G(N), and the discharging module 30 is configured to connect the pixel electrode 10 in the Nth row and the Mth column with the discharge electrode 40 under the control of (N−1)th scanning line G(N−1) Since the display panel is progressively scanned, the pixel electrode 10 in the Nth row and the Mth column can be connected to the discharge electrode 40 by the discharging module 30 before the charging module 20 writes the signal of the Mth data line D(M) into the pixel electrode 10 in the Nth row and the Mth column, and the discharge electrode 40 releases the voltage of the pixel electrode 10 in the Nth row and the Mth column, so that the voltage of the pixel electrode 10 in the Nth row and the Mth column is restored to zero or close to zero. As a result, the power consumption of the pixel electrode 10 during the charging/discharging process can be reduced, and the charging/discharging time period of the pixel electrode 10 can be reduced.

In some embodiments, the charging module 20 includes a first transistor T1, where a gate of the first transistor T1 is electrically connected to the Nth scanning line G(N), one of a source and a drain of the first transistor T1 is electrically connected to the Mth data line D(M), and the other one of the source and the drain of the first transistor T1 is electrically connected to the pixel electrode 10 in the Nth row and the Mth column;
the discharging module 30 includes a second transistor T2, wherein a gate of the second transistor T2 is electrically connected to the (N−1)th scanning line G(N−1), one of a source and a drain of the second transistor T2 is electrically connected to the pixel electrode 10 in the Nth row and the Mth column, and the other one of the source and the drain of the second transistor T2 is electrically connected to the discharge electrode 40; and both the first transistor T1 and the second transistor T2 are N-type transistors.

Specifically, when the signal of the (N−1)th scanning line G(N−1) is at a high level, the signal of the (N)th scanning line G(N) is at a low level, so that the first transistor T1 is turned off and the second transistor T2 is turned on. As such, the pixel electrode 10 in the Nth row and the Mth column is connected with the discharge electrode 40 by the second transistor T2, so that the discharge electrode 40 releases the voltage of the pixel electrode 10 in the Nth row and the Mth column to cause the voltage of the pixel electrode 10 in the Nth row and the Mth column to be restored to zero or close to zero.

When the signal of the Nth scanning line G(N) is at a high level, the signal of the (N−1)th scanning line G(N−1) is at a low level, so that the first transistor T1 is turned on and the second transistor T2 is turned off. As such, the signal of the Mth data line D(M) is written into the pixel electrode 10 in the Nth row and the Mth column by the first transistor T1.

Referring to FIG. 9, which is a voltage timing diagram of a pixel electrode of a sub-pixel VP1 and a pixel electrode of a sub-pixel VP2 in FIG. 7. Voltage variation of the pixel electrode of the sub-pixel VP1 and the pixel electrode of the sub-pixel VP2 is described as a specific implementation process, where the sub-pixel VP1 is a sub-pixel in the Nth row and the (M−2)th column and the sub-pixel VP2 is a sub-pixel in the Nth row and the (M−1)th column. In a previous frame, when the signal of the (N−1)th scanning line G(N−1) is at a high level, the signal of the Nth scanning line G(N) is at a low level, so that the first transistor T1 is turned off, and the second transistor T2 is turned on. As such, the pixel electrode 10 of the sub-pixel VP1 is connected with the discharge electrode 40 by the second transistor T2, so that the voltage of the pixel electrode 10 of the sub-pixel VP1 and the voltage of the pixel electrode 10 of the sub-pixel VP2 are both reduced to zero. In a subsequent frame, at this time, the signal of the (M−2)th data line is at a low level of −5V, and the signal of the (M−1)th data line is at a low level of +5V. When the signal of the Nth scanning line G(N) is at a high level, the signal of the (N−1)th scanning line G(N−1) is at a low level, so that the first transistor T1 is turned on, and the second transistor T2 is turned off. As such, the signal of the (M−2)th data line is written into the pixel electrode 10 of the sub-pixel VP1 by the first transistor T1, the voltage of the pixel electrode of the sub-pixel VP1 is −5V, the signal of the (M−1)th data line is written into the pixel electrode 10 of the sub-pixel VP2 by the first transistor T1, and the voltage of the pixel electrode of the sub-pixel VP2 is +5V.

Referring to FIG. 10, which is a sixth schematic structural diagram of a pixel driving circuit 100 provided in the present application; the present embodiment differs from the pixel driving circuit 100 provided in FIG. 8 in that the charging module 20 includes a first transistor T1, where a gate of the first transistor T1 is electrically connected to the Nth scanning line G(N), one of the source and the drain of the first transistor T1 is electrically connected to the Mth data line D(M), and the other one of the source and the drain of the first transistor T1 is electrically connected to the pixel electrode 10 in the Nth row and the Mth column; the discharging module 30 includes a second transistor T2, wherein a gate of the second transistor T2 is electrically connected to the (N−1)th scanning line G(N−1), one of a source and a drain of the second transistor T2 is electrically connected to the pixel electrode 10 in the Nth row and the Mth column, and the other one of the source and the drain of the second transistor T2 is electrically connected to the discharge electrode 40; and both the first transistor T1 and the second transistor T2 are P-type transistors.

Specifically, when the signal of the (N−1)th scanning line G(N−1) is at a low level, the signal of the (N)th scanning line G(N) is at a high level, so that the first transistor T1 is turned off and the second transistor T2 is turned on. As such, the pixel electrode 10 in the Nth row and the Mth column is connected with the discharge electrode 40 by the second transistor T2, so that the discharge electrode 40 releases the voltage of the pixel electrode 10 in the Nth row and the Mth column to cause the voltage of the pixel electrode 10 in the Nth row and the Mth column to be restored to zero or close to zero.

When the signal of the Nth scanning line G(N) is at a low level, the signal of the (N−1)th scanning line G(N−1) is at a high level, so that the first transistor T1 is turned on and the second transistor T2 is turned off. As such, the signal of the Mth data line D(M) is written into the pixel electrode 10 in the Nth row and the Mth column by the first transistor T1.

Referring to FIG. 11, which is a seventh schematic structural diagram of a pixel driving circuit 100 provided in the present application; and FIG. 12 is a schematic diagram of the pixel driving circuit 100 in the Nth row and the Mth column in FIG. 11. The present embodiment differs from the pixel driving circuit 100 provided in FIG. 3 in that the pixel driving circuit further includes: a plurality of scanning lines G extending in a transverse direction that are sequentially arranged from top to bottom, a plurality of data lines D extending in a longitudinal direction that are sequentially arranged from left to right and insulated from the plurality of scanning lines G, and a plurality of sub-pixels arranged in an array that are defined by the plurality of scanning lines G and the plurality of data lines D; where, both M and N are preset as positive integers, and the charging module 20 is electrically connected to the Mth data line D(M), the Nth scanning line G(N), and the pixel electrode 10 in the Nth row and the Mth column; where, the signal control line S is the Nth scanning line G(N), and the discharging module 30 is electrically connected to the Nth scanning line G(N), the discharge electrode 40, and the pixel electrode 10 in the Nth row and the Mth column; where the charging module 20 writes a signal of the Mth data line D(M) into the pixel electrode 10 in the Nth row and the Mth column when the signal of the Nth scanning line G(N) has a first polarity; and the discharging module 30 connects the pixel electrode 10 in the Nth row and the Mth column with the discharge electrode 40 when the signal of the Nth scanning line G(N) has a second polarity, where the first polarity is one of a positive polarity and a negative polarity, and the second polarity is the other one of the positive polarity and the negative polarity.

In the present application, the signal control line S is set as the Nth scanning line G(N), and the charging module 20 write a signal of the Mth data line D(M) into the pixel electrode 10 in the Nth row and the Mth column under the control of the Nth scanning line G(N), and the discharging module 30 connects the pixel electrode 10 in the Nth row and the Mth column with the discharge electrode 40 under the control of Nth scanning line G(N). The discharging module connects the pixel electrode in the Nth row and the Mth column with the discharge electrode when the signal of the Nth scanning line has a second polarity, where the first polarity is one of a positive polarity and a negative polarity, and the second polarity is the other one of the positive polarity and the negative polarity. Therefore, the pixel electrode 10 in the Nth row and the Mth column can be connected to the discharge electrode 40 by the discharging module 30 before the charging module 20 writes the signal of the Mth data line D(M) into the pixel electrode 10 in the Nth row and the Mth column, and the discharge electrode 40 releases the voltage of the pixel electrode 10 in the Nth row and the Mth column, so that the voltage of the pixel electrode 10 in the Nth row and the Mth column is restored to zero or close to zero. As a result, the power consumption of the pixel electrode 10 during the charging/discharging process can be reduced, and the charging/discharging time period of the pixel electrode 10 can be reduced.

In some embodiments, the charging module 20 includes a first transistor T1, where a gate of the first transistor T1 is electrically connected to the Nth scanning line G(N), one of a source and a drain of the first transistor T1 is electrically connected to the Mth data line D(M), and the other one of the source and the drain of the first transistor T1 is electrically connected to the pixel electrode 10 in the Nth row and Mth column; the discharging module 30 includes a second transistor T2, a gate of the second transistor T2 is electrically connected to the Nth scanning line G(N), one of a source and a drain of the second transistor T2 is electrically connected to the pixel electrode 10 in the Nth row and the Mth column, and the other one of the source and the drain of the second transistor T2 is electrically connected to the discharge electrode 40; and the first transistor T1 is an N-type transistor, and the second transistor T2 is a P-type transistor.

Specifically, when the signal of the (N)th scanning line G(N) is at a low level, the first transistor T1 is turned off and the second transistor T2 is turned on. As such, the pixel electrode 10 in the Nth row and the Mth column is connected with the discharge electrode 40 by the second transistor T2, so that the discharge electrode 40 releases the voltage of the pixel electrode 10 in the Nth row and the Mth column to cause the voltage of the pixel electrode 10 in the Nth row and the Mth column to be restored to zero or close to zero.

When the signal of the (N)th scanning line G(N) is at a high level, the first transistor T1 is turned on and the second transistor T2 is turned off. As such, the signal of the Mth data line D(M) is written into the pixel electrode 10 in the Nth row and the Mth column by the first transistor T1.

Referring to FIG. 13, which is an eighth schematic structural diagram of a pixel driving circuit 100 provided in the present application; the present embodiment differs from the pixel driving circuit 100 provided in FIG. 12 in that the charging module 20 includes a first transistor T1, where a gate of the first transistor T1 is electrically connected to the Nth scanning line G(N), one of the source and the drain of the first transistor T1 is electrically connected to the Mth data line D(M), and the other one of the source and the drain of the first transistor T1 is electrically connected to the pixel electrode 10 in the Nth row and the Mth column; the discharging module 30 includes a second transistor T2, wherein a gate of the second transistor T2 is electrically connected to the Nth scanning line G(N), one of a source and a drain of the second transistor T2 is electrically connected to the pixel electrode 10 in the Nth row and the Mth column, and the other one of the source and the drain of the second transistor T2 is electrically connected to the discharge electrode 40; and the first transistor T1 is a P-type transistor, and the second transistor T2 is a an N-type transistor.

Specifically, when the signal of the (N)th scanning line G(N) is at a high level, so that the first transistor T1 is turned off and the second transistor T2 is turned on. As such, the pixel electrode 10 in the Nth row and the Mth column is connected with the discharge electrode 40 by the second transistor T2, so that the discharge electrode 40 releases the voltage of the pixel electrode 10 in the Nth row and the Mth column to cause the voltage of the pixel electrode 10 in the Nth row and the Mth column to be restored to zero or close to zero.

When the signal of the (N)th scanning line G(N) is at a low level, the first transistor T1 is turned on and the second transistor T2 is turned off. As such, the signal of the Mth data line D(M) is written into the pixel electrode 10 in the Nth row and the Mth column by the first transistor T1.

An embodiment of the present application further provides a display panel, including the pixel driving circuit 100 as described above.

A principle of the display panel for resolving the problem is similar to that of the pixel driving circuit 100. Therefore, implementations and beneficial effects of the display panel can refer to the foregoing description of the pixel driving circuit 100. Details are not described herein again.

The pixel driving circuit and the display panel provided in the embodiments of the present application are described in detail above. A specific example is used herein to describe a principle and an implementation of the present application. The description of the foregoing embodiments is merely used to help understand a method and a core idea of the present application. In addition, a person skilled in the art may make changes in a specific implementation manner and an application scope according to an idea of the present application. In conclusion, content of this specification should not be construed as a limitation on the present application.

What is claimed is:

1. A pixel driving circuit, comprising:
a pixel electrode;
a charging module electrically connected to a data line, a scanning line, and the pixel electrode, wherein the charging module is configured to write a signal of the data line to the pixel electrode under the control of a signal of the scanning line; and
a discharging module electrically connected to a signal control line, a discharge electrode, and the pixel electrode, wherein the discharging module is configured to connect the pixel electrode to the discharging electrode under the control of a signal of the signal control line.

2. The pixel driving circuit of claim 1, further comprising:
a storage capacitor, wherein a first electrode of the storage capacitor is the pixel electrode, a second electrode of the storage capacitor is a first common electrode, and the discharge electrode comprises the first common electrode.

3. The pixel driving circuit of claim 1, further comprising:
a liquid crystal capacitor, wherein a first electrode of the liquid crystal capacitor is the pixel electrode, a second electrode of the liquid crystal capacitor is a second common electrode, and the discharge electrode comprises the second common electrode.

4. The pixel driving circuit of claim 1, wherein the charging module comprises:
a first transistor, wherein a gate of the first transistor is electrically connected to the scanning line, one of a source and a drain of the first transistor is electrically connected to the data line, and the other one of the source and the drain of the first transistor is electrically connected to the pixel electrode.

5. The pixel driving circuit of claim 1, wherein the discharging module comprises:
a second transistor, wherein a gate of the second transistor is electrically connected to the signal control line, one of a source and a drain of the second transistor is electrically connected to the pixel electrode, and the other one of the source and the drain of the second transistor is electrically connected to the discharge electrode.

6. The pixel driving circuit of claim 1, further comprising:
a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines;
wherein, both M and N are preset as positive integers, N is greater than or equal to 2, and the charging module is electrically connected to the Mth data line, the Nth scanning line, and the pixel electrode in the Nth row and the Mth column;
wherein, the signal control line is the (N−1)th scanning line, and the discharging module is electrically connected to the (N−1)th scanning line, the discharge electrode, and the pixel electrode in the Nth row and the Mth column.

7. The pixel driving circuit of claim 6, wherein the charging module comprises:
a first transistor, wherein a gate of the first transistor is electrically connected to the Nth scanning line, one of a source and a drain of the first transistor is electrically connected to the Mth data line, and the other one of the source and the drain of the first transistor is electrically connected to the pixel electrode in the Nth row and the Mth column;
the discharging module comprises:
a second transistor, wherein a gate of the second transistor is electrically connected to the (N−1)th scanning line, one of a source and a drain of the second transistor is electrically connected to the pixel electrode in the Nth row and the Mth column, and the other one of the source and the drain of the second transistor is electrically connected to the discharge electrode;
wherein both the first transistor and the second transistor are N-type transistors or P-type transistors.

8. The pixel driving circuit of claim 1, further comprising:
a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines;
wherein, both M and N are preset as positive integers, and the charging module is electrically connected to the Mth data line, the Nth scanning line, and the pixel electrode in the Nth row and the Mth column;
wherein, the signal control line is the Nth scanning line, and the discharging module is electrically connected to the Nth scanning line, the discharge electrode, and the pixel electrode in the Nth row and the Mth column; wherein,
the charging module writes a signal of the Mth data line into the pixel electrode in the Nth row and the Mth column when the signal of the Nth scanning line has a first polarity;
the discharging module connects the pixel electrode in the Nth row and the Mth column with the discharge electrode when the signal of the Nth scanning line has a second polarity, wherein the first polarity is one of a positive polarity and a negative polarity, and the second polarity is the other one of the positive polarity and the negative polarity.

9. The pixel driving circuit of claim 8, wherein the charging module comprises:
a first transistor, wherein a gate of the first transistor is electrically connected to the Nth scanning line, one of a source and a drain of the first transistor is electrically connected to the Mth data line, and the other one of the source and the drain of the first transistor is electrically connected to the pixel electrode in the Nth row and the Mth column;
the discharging module comprises:
a second transistor, wherein a gate of the second transistor is electrically connected to the Nth scanning line, one of a source and a drain of the second transistor is electrically connected to the pixel electrode in the Nth row and the Mth column, and the other one of the source and the drain of the second transistor is electrically connected to the discharge electrode;
wherein the first transistor is an N-type transistor or a P-type transistor, and the second transistor is a P-type transistor or an N-type transistor.

10. The pixel driving circuit of claim 1, wherein the discharge electrode is a ground terminal.

11. A display panel, comprising a driving circuit comprising:
the pixel driving circuit comprises:
a pixel electrode;
a charging module electrically connected to a data line, a scanning line, and the pixel electrode, wherein the charging module is configured to write a signal of the data line to the pixel electrode under the control of a signal of the scanning line; and
a discharging module electrically connected to a signal control line, a discharge electrode, and the pixel electrode, wherein the discharging module is configured to connect the pixel electrode to the discharging electrode under the control of a signal of the signal control line.

12. The display panel of claim 11, wherein the pixel driving circuit further comprises:
a storage capacitor, wherein a first electrode of the storage capacitor is the pixel electrode, a second electrode of the storage capacitor is a first common electrode, and the discharge electrode comprises the first common electrode.

13. The display panel of claim 11, wherein the pixel driving circuit further comprises:
a liquid crystal capacitor, wherein a first electrode of the liquid crystal capacitor is the pixel electrode, a second electrode of the liquid crystal capacitor is a second common electrode, and the discharge electrode comprises the second common electrode.

14. The display panel of claim 11, wherein the charging module comprises:
a first transistor, wherein a gate of the first transistor is electrically connected to the scanning line, one of a source and a drain of the first transistor is electrically connected to the data line, and the other one of the source and the drain of the first transistor is electrically connected to the pixel electrode.

15. The display panel of claim 11, wherein the discharging module comprises:
a second transistor, wherein a gate of the second transistor is electrically connected to the signal control line, one of a source and a drain of the second transistor is electrically connected to the pixel electrode, and the other one of the source and the drain of the second transistor is electrically connected to the discharge electrode.

16. The display panel of claim 11, further comprising:
a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines;
wherein, both M and N are preset as positive integers, N is greater than or equal to 2, and the charging module is electrically connected to the Mth data line, the Nth scanning line, and the pixel electrode in the Nth row and the Mth column;
wherein, the signal control line is the (N−1)th scanning line, and the discharging module is electrically connected to the (N−1)th scanning line, the discharge electrode, and the pixel electrode in the Nth row and the Mth column.

17. The display panel of claim 16, wherein the charging module comprises:
a first transistor, wherein a gate of the first transistor is electrically connected to the Nth scanning line, one of a source and a drain of the first transistor is electrically connected to the Mth data line, and the other one of the source and the drain of the first transistor is electrically connected to the pixel electrode in the Nth row and the Mth column;
the discharging module comprises:
a second transistor, wherein a gate of the second transistor is electrically connected to the (N−1)th scanning line, one of a source and a drain of the second transistor is electrically connected to the pixel electrode in the Nth row and the Mth column, and the other one of the source and the drain of the second transistor is electrically connected to the discharge electrode;
wherein both the first transistor and the second transistor are N-type transistors or P-type transistors.

18. The display panel of claim 11, further comprising:
a plurality of scanning lines extending in a transverse direction that are sequentially arranged from top to bottom, a plurality of data lines extending in a longitudinal direction that are sequentially arranged from left to right and insulated from the plurality of scanning lines, and a plurality of sub-pixels arranged in an array that are defined by the plurality of scanning lines and the plurality of data lines;
wherein, both M and N are preset as positive integers, and the charging module is electrically connected to the Mth data line, the Nth scanning line, and the pixel electrode in the Nth row and the Mth column;
wherein, the signal control line is the Nth scanning line, and the discharging module is electrically connected to the Nth scanning line, the discharge electrode, and the pixel electrode in the Nth row and the Mth column; wherein,
the charging module writes a signal of the Mth data line into the pixel electrode in the Nth row and the Mth column when the signal of the Nth scanning line has a first polarity;
the discharging module connects the pixel electrode in the Nth row and the Mth column with the discharge electrode when the signal of the Nth scanning line has a second polarity, wherein the first polarity is one of a positive polarity and a negative polarity, and the second polarity is the other one of the positive polarity and the negative polarity.

19. The display panel of claim 18, wherein the charging module comprises:
a first transistor, wherein a gate of the first transistor is electrically connected to the Nth scanning line, one of a source and a drain of the first transistor is electrically connected to the Mth data line, and the other one of the source and the drain of the first transistor is electrically connected to the pixel electrode in the Nth row and the Mth column;
the discharging module comprises:
a second transistor, wherein a gate of the second transistor is electrically connected to the Nth scanning line, one of a source and a drain of the second transistor is electrically connected to the pixel electrode in the Nth row and the Mth column, and the other one of the source and the drain of the second transistor is electrically connected to the discharge electrode;
wherein the first transistor is an N-type transistor or a P-type transistor, and the second transistor is a P-type transistor or an N-type transistor.

20. The display panel of claim 11, wherein the discharge electrode is a ground terminal.
